(19) United States
(12) Patent Application Publication
(10) Pub. No.: US 2014/0200793 A1
(43) Pub. Date: Jul. 17, 2014

(54) SYSTEM AND METHOD FOR DETERMINING AND DISPLAYING A FUEL-EQUIVALENT DISTANCE-PER-ENERGY CONSUMPTION RATE

(71) Applicant: Toyota Motor Engineering & Manufacturing North America, Inc., (US)

(72) Inventor: Mohammad E. Dufford, Los Angeles, CA (US)

(73) Assignee: Toyota Motor Engineering & Manufacturing North America, Inc., Erlanger, KY (US)

(21) Appl. No.: 13/743,279

(22) Filed: Jan. 16, 2013

(51) Int. Cl. F02D 41/26

(52) U.S. Cl. CPC F02D 41/26
USPC 701/103; 701/101

(57) ABSTRACT

A method and system for determining and displaying a rate corresponding to the distance travelled by a vehicle per an amount of fuel-equivalent energy consumption, and more particularly for determining and displaying a number of miles or kilometers travelled per a gallon or a liter of total fuel and fuel-equivalent non-fuel energy consumed. The system includes an electronic control unit, an engine, a fuel controller, a battery, a battery management and control unit and a display. The method and system determine the fuel-equivalent energy consumption sum based on a constant energy conversion factor or an energy conversion efficiency loss number or factor determined in real time. The method and system also determine and display a fuel-equivalent cost for travelling a kilometer or a mile of the distance travelled. The method and system also change an operation of the vehicle based on the determined rate and fuel-equivalent cost.

### BACKGROUND

1. Field

The present invention relates to a method and a system for determining and displaying a fuel-equivalent distance-per-energy consumption rate and more particularly, to a method and a system for determining and displaying a number of miles travelled by the vehicle per a gallon of total fuel and non-fuel energy consumed over a time period or a number of kilometers travelled by the vehicle per a liter of total fuel and non-fuel energy consumed over a time period.

2. Description of the Related Art

With global energy prices rapidly increasing, a user of a vehicle having a rechargeable battery is increasingly interested in evaluating what distance the vehicle can travel for an amount of energy consumed. Because conventional vehicles have relied solely on a fuel energy source, vehicle users have been accustomed to evaluating the number of miles that the vehicle can travel per one gallon of fuel (MPG) or the number of kilometers that the vehicle can travel per one liter of fuel (Km/l).

For hybrid and plug-in hybrid vehicles, a drawback of presenting MPG or Km/l information merely based on fuel consumption is that the vehicle user cannot make an accurate assessment of the distance the vehicle can travel per an amount of energy consumed since non-fuel energy consumption (e.g., electrical energy consumption) is not taken into account. For example, the battery may be discharging, thereby depleting energy, and yet the electrical energy consumption would not be taken into account in the fuel MPG or Km/l information displayed to a user of the vehicle.

In order to enable the vehicle users to evaluate the energy efficiency of the vehicle, manufacturers have sought novel ways to convey energy efficiency information to the vehicle users. A drawback of the energy efficiency indicators has been that an average vehicle user without engineering expertise may not find the energy efficiency information tangible and easy to understand.

Thus, there is a need for a method and a system directed to determining and displaying easily understandable data regarding what distance a vehicle can travel for an amount of fuel or fuel-equivalent non-fuel energy consumed. Furthermore, there is a need for a method and a system for determining and displaying a fuel-equivalent MPG or Km/l rate based on gallons or liters of total fuel and fuel-equivalent non-fuel energy consumed. There is also a need for a method and a system directed to displaying a fuel-equivalent energy cost corresponding to a cost amount for travelling a kilometer or a mile of the distance travelled over a time period during which the total fuel and fuel-equivalent non-fuel energy is consumed. There is yet another need for a method and a system of determining a distance-per-energy consumption rate for tuning an operation of the engine and a charging/discharging operation of the battery in order to reach an operating point that maximizes total energy efficiency.

### SUMMARY

The present invention relates to a method and a system for determining and displaying a fuel-equivalent distance-per-energy consumption rate and more particularly to a method and a system for determining and displaying a number of miles travelled by the vehicle per one gallon of total fuel and fuel-equivalent non-fuel energy consumed or a number of kilometers travelled by the vehicle per one liter of total fuel and fuel-equivalent non-fuel energy consumed. In one embodiment, the present invention may be, for example, a computer-based method for determining and displaying a fuel-equivalent distance-per-energy consumption rate of a vehicle, the method including: determining, using a fuel controller coupled to an engine or a fuel cell, a fuel consumption rate or amount; determining, using a battery management and charging unit (BMCU) coupled to a battery, an electrical energy consumption rate or amount; determining, using an electronic control unit coupled to a speed sensor, a distance travelled by the vehicle during a time period; determining, using the electronic control unit, the fuel-equivalent distance-per-energy consumption rate based on the fuel and electrical energy consumption rates or amounts and based on the determined distance travelled during the time period; and displaying, using a display coupled to the electronic control unit, an indicator based on the fuel-equivalent distance-per-energy consumption rate for indicating an amount of distance travelled by the vehicle for an amount of fuel-equivalent energy consumed.

In another embodiment, the present invention may be computer-based method for determining and displaying a fuel-equivalent distance-per-energy rate of a vehicle, the method including: determining, using a fuel controller coupled to an engine or a fuel cell, a first energy consumption sum amount corresponding to an amount of fuel energy consumed by an engine or a fuel cell during a time period; determining, using an electronic control unit, a second energy consumption sum amount corresponding to an amount of energy consumed using a non-fuel energy source during the time period; determining, using the electronic control unit and a speed sensor coupled to the electronic control unit, a distance travelled by the vehicle during the time period; determining, using the electronic control unit, a fuel-equivalent total energy consumption sum amount based on the first and the second consumption sum amounts; determining, using the electronic control unit, the fuel-equivalent distance-per-energy consumption rate based on the determined fuel-equivalent total energy consumption sum amount and the determined distance travelled during the time period, such that the fuel-equivalent distance-per-energy consumption rate corresponds to a number of or a fraction of miles travelled per a gallon of the fuel-equivalent total energy consumption sum amount or corresponds to a number of or a fraction of kilometers travelled per a liter of the fuel-equivalent total energy consumption sum amount; and displaying, using a display coupled to the electronic control unit, an indicator based on the determined fuel-equivalent distance-per-energy consumption rate.

In yet another embodiment, the present invention may be a vehicle including: an engine; a fuel controller coupled to the engine and configured to determine a fuel consumption rate or amount of the engine; a battery management and charging unit (BMCU) coupled to a battery and configured to control and monitor charging and discharging of the battery and further configured to determine an electrical energy consumption rate or amount of the battery; an energy generation unit including a solar panel, a ram induction generator, a regenerative braking unit, a heat exchange unit or combinations thereof, the energy generation unit having an energy generation rate or amount; an electronic control unit coupled to the engine, the energy generation unit, the fuel controller and the BMCU and configured to: determine, using a speed sensor, a distance travelled by the vehicle during a time period, determine a fuel-equivalent distance-per-energy consumption rate based on the determined fuel consumption rate or amount, electrical energy consumption rate or amount, energy generation rate or amount and the distance travelled during the time period; and the vehicle further including a display coupled to the electronic control unit and configured to display an indicator based on the determined fuel-equivalent distance-per-energy consumption rate, the indicator corresponding to an amount of distance travelled by the vehicle for an amount of fuel-equivalent energy consumed.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram of a vehicle according to an embodiment of the present invention;

FIG. 2 is a control logic block diagram illustrating how a fuel-equivalent total energy consumption sum amount is determined according to an embodiment of the present invention;

FIG. 3A is a graph depicting an example of a state of charge (SOC) of the battery during an operation of the vehicle according to an exemplary embodiment of the present invention;

FIG. 3B is a graph depicting the change in the fuel consumption and fuel-equivalent total energy consumption sum amounts as the SOC of the battery varies according to the embodiment of the present invention illustrated in FIG. 3A;

FIG. 4 is a decision flowchart diagram showing a method of determining and displaying a fuel-equivalent distance-per-energy rate according to an embodiment of the present invention;

FIG. 5 is a decision flowchart diagram showing a method of determining and displaying a fuel-equivalent distance-per-energy rate according to another embodiment of the present invention; and

FIG. 6 is a display screen of the display of the vehicle having indicators showing a fuel-equivalent distance-per-energy rate, a cost-per-distance travelled and a total energy efficiency determined and updated in real time as the vehicle is operated according to an embodiment of the present invention.

### DETAILED DESCRIPTION

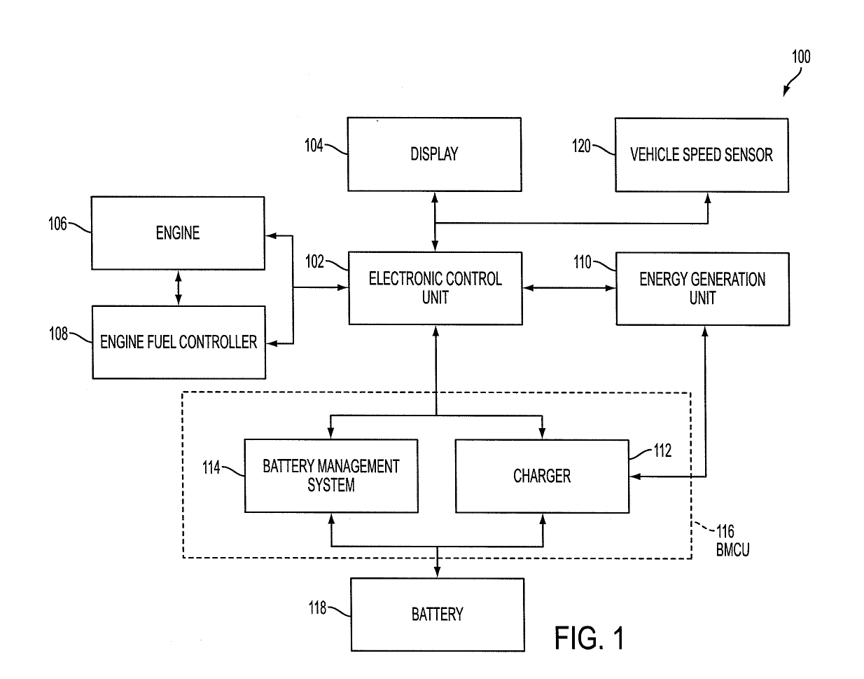

Referring to FIG. 1, a block diagram is shown of a vehicle 100 according to an embodiment of the present invention. The vehicle 100 may include an electronic control unit 102, a display 104, an engine 106, an engine fuel controller 108, an energy generation unit 110, a charger 112, a battery management and control unit (hereinafter referred to as BMCU) 116, a battery 118 and a vehicle speed sensor 120. The BMCU 116 may include a battery management system (BMS) 114 and a charger 112. The charger 112 may be configured to be coupled to an external charger. The vehicle 100 may also include a motor/generator and an HVAC (Heating, Ventilation and Air Conditioning) unit.

The vehicle 100 operates by utilizing a fuel source and a non-fuel source of energy. The vehicle 100 may be an alternative fuel vehicle, a hybrid electric vehicle, a plug-in hybrid electric vehicle, an electric vehicle or a solar powered vehicle or any other vehicle utilizing a non-fuel source of energy without limiting the scope of the present invention. The vehicle 100 may determine and display a fuel-equivalent distance-per-energy consumption rate by converting energy consumption in all forms of energy into a fuel-equivalent energy consumption rate or amount.

The electronic control unit 102 may be in continuous or periodic communication with the display 104, the engine 106, the engine fuel controller 108, the BMS 114, the charger 112 and other units of the vehicle 100 using transmission of electronic signals through a Control Area Network (CAN) bus. In other embodiments, the control and communication may be over various other types of serial communication links, direct wirings, digital communication buses, wireless communications or other communication links.

The engine fuel controller 108 controls and monitors injection of fuel into the engine 106 for an internal combustion operation. To determine the fuel consumption rate or amount, the electronic control unit 102 may be in periodic communication with the engine fuel controller 108. The fuel controller 108 may be a fuel injector system. The amount of fuel supplied to the engine 106 may be determined based in part on the pulse width of the fuel injector. The engine fuel controller 108 and/or the electronic control unit 102 may determine a fuel consumption rate using a mass airflow sensor, an oxygen sensor, a throttle position sensor monitoring the throttle valve position, a coolant temperature sensor, an air pressure sensor, engine speed sensor, and/or other input sensors generating signals allowing the electronic control unit 102 to determine the fuel consumption rate or amount. The electronic control unit 102 may use a look-up table, an algorithm or data stored in a memory (not shown) to determine the fuel consumption amount or value. The memory may be integral to or connected to the electronic control unit 102. The electronic control unit 102 and the memory may reside in an Application Specific Integrated Circuit (ASIC). The ASIC may reside in a wireless modem. In the alternative, the electronic control unit 102 and the memory may reside as discrete components in the wireless modem.

Various types of fuel may be used by the vehicle 100 including but not limited to gasoline, diesel, ethanol, biodiesel, natural gas, propane, hydrogen or combinations thereof. The vehicle 100 may also include a fuel cell in lieu of or in addition to the engine 106 which may charge the battery 118 and/or a capacitor by converting a fuel through a chemical reaction with an oxidizing agent. A fuel consumption sum amount may be calculated and communicated with the electronic control unit 102 in order to determine the fuel consumption rate.

To determine the fuel-equivalent distance-per-energy consumption rate, the electronic control unit 102 may determine the distance travelled during a time period. In one embodiment, the electronic control unit 102 may determine the vehicle speed during the time period using the vehicle speed sensor 120. The electronic control unit 102 may then integrate the vehicle speed over the time period to determine the distance travelled by the vehicle 100 during the time period.

In one embodiment, the battery 118 provides electrical energy for the operation of the vehicle 100. The battery 118 may be any rechargeable battery that is capable of being utilized in the vehicle 100 and may include a plurality of battery cells. The battery 118 may be charged, using the motor/generator, by converting fuel energy into electrical energy stored by the vehicle 100. The battery 118, as in for example, an all-electric or a plug-in hybrid vehicle, may be charged using an external charger coupled to the charger 112 or the battery 118.

The electrical energy consumption can be determined by measuring the electrical energy in and out of the battery 118. A change in the level of a state of charge (SOC) of the battery 118 may indicate an electrical consumption rate or amount. The BMS 114 may measure, using sensors, parameters that are used to determine the SOC of the battery 118. The sensors may measure a voltage, a current, a temperature, charge acceptance, an internal resistance, self-discharges, magnetic properties, a state of health and/or other states or parameters of the battery 118. In one embodiment, the electronic control unit 102 may determine an SOC percentage or ratio of the battery 118 based on an energy value stored in the battery 118 or the vehicle 100 relative to the current charging capacity of the battery 118. In another embodiment, the BMS 114 can transmit control signals to relays for selectively activating a connection of the battery 118 to various loads positioned inside the vehicle 100. The loads can be, for example, various units or devices of the vehicle 100 having programmable memory items. The electronic control unit 102 may or may not manipulate the SOC or the display SOC. In one embodiment, the electronic control unit 102 may have access to the SOC of the vehicle 100 or the battery 118 for controlling the display 104 and operations of others units of the vehicle 100.

In another embodiment, the SOC may be determined based on the stored energy value relative to a reference capacity for the battery 118 stored in the memory. In yet another embodiment, the SOC may be measured as a percentage or a ratio relative to another predetermined value associated with the battery 118. The SOC may be determined in amp hours (Ah) or kilowatt hours (kW-h) of energy. In another embodiment, the electronic control unit 102 determines a display SOC based on the measured SOC of the battery 118 such that the display SOC may differ from the measured SOC for a range of SOC values. For example, the display SOC may correspond to a percentage greater than the measured SOC when the measured SOC is higher than a threshold. In an embodiment, the electronic control unit 102 may utilize the display SOC to determine the fuel-equivalent consumption rate or amount. Other systems or methods known in the art for determining an SOC percentage, value or number may be utilized in the vehicle 100 without limiting the scope of the present invention.

The electronic control unit 102 may determine the fuel-equivalent consumption rate of the electrical energy consumption based on the variation in the SOC of the battery 118. For example, a 33.7 kW-h change in the SOC may correspond to energy stored in approximately one gallon of gasoline. The consumed electrical energy may be converted into a fuel-equivalent amount of energy and added with the fuel consumption sum amount to obtain a fuel-equivalent total energy consumption sum amount as described in details below. Once the total number of gallons or liters of a fuel-equivalent total energy consumption sum amount is determined, the electronic control unit 102 may divide the travelled distance (miles or kilometers) by the amount of energy of the fuel-equivalent total energy consumption sum amount (gallons or liters) to determine a fuel-equivalent distance-per-energy consumption rate, e.g., in miles per gallon equivalent (MPG-e) or kilometers per liter equivalent (Km/l-e).

In one embodiment, the battery 118 may be coupled to an external charger before the departure time of the vehicle 100. In one embodiment, the BMCU 116 is coupled to an external power source. The external power source includes an A.C. power source which is coupled to an external charger positioned outside the vehicle 100. The external charger may be any of the various types of electric vehicle charging stations, wall-mountable electric charging solutions or electric vehicle supply equipment utilized in residential or commercial settings. The external charger is coupled to the charger 112 which may be positioned inside the vehicle 100 in one embodiment of the present invention as shown in FIG. 1. The charger 112 may be coupled to or include an A.C. to D.C. converter for converting the A.C. voltage or current received from the external power source to D.C. voltage or current directed to the battery 118. In an alternative embodiment, the external power source may be coupled to the charger 112 or the BMS 114 without using an external charger. In yet another embodiment, the external power source may be a D.C. power source. In such an embodiment, the charger 112 would not be required to be coupled to or include an A.C. to D.C. converter, and the vehicle 100 may include a D.C. to D.C. converter. The electronic control unit 102 may determine the fuel-equivalent electrical energy consumed based on the charging/discharging operation of the BMCU 114.

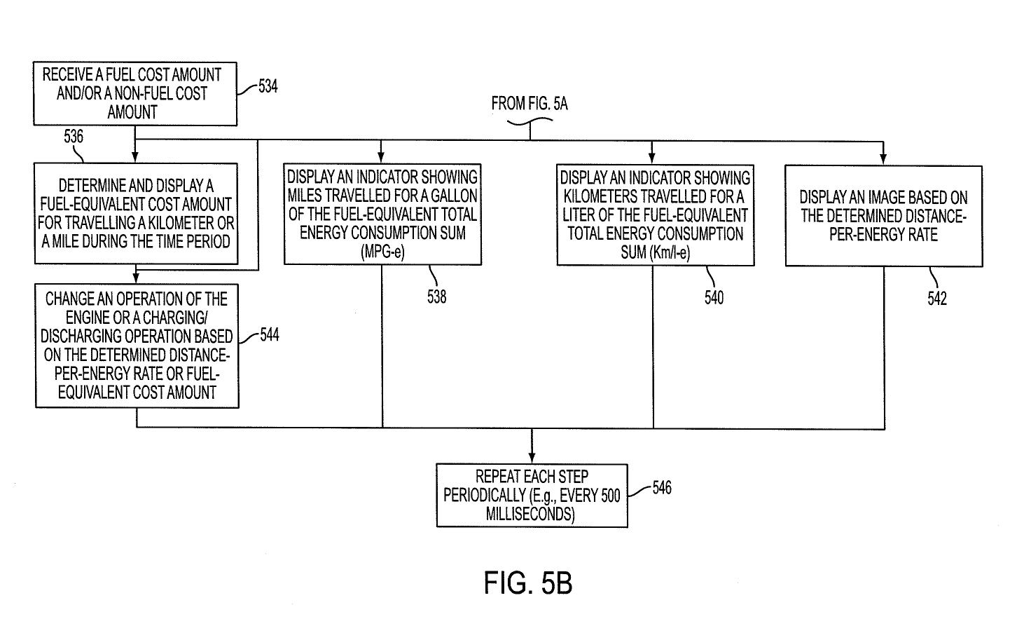

The stored electrical energy may be obtained through charging using an external power source, fuel consumption energy from the engine 106, energy generated by the energy generation unit 110 (e.g., via regenerative braking) or other means. In an embodiment, the battery 118 may also be a capacitor which may be charged by an energy generation unit 110. A supplemental motor/generator may be configured to apply a torque or a mechanical force to operate the vehicle 100. The energy generation unit 110 may include a solar panel, a ram induction generator, a regenerative braking unit, a heat exchange unit or combinations thereof. The supplemental motor/generator may supplement the torque applied by the engine 106. The vehicle 100 may also include a catalytic converter connected to the engine 106 to generate heat used by the energy generation unit 110 to charge the battery 118. The supplemental motor/generator may then be powered by discharging the battery 118 or the capacitor. In one embodiment, the electronic control unit 102 determines the fuel-equivalent non-fuel energy consumption sum amount based on the energy generated by the energy generation unit 110 and further based on the energy conversion efficiency of the energy generation operation as discussed in details with respect to FIG. 5 below.

In one embodiment, the electronic control unit 102 periodically (e.g., every 500 milliseconds) determines a fuel-equivalent distance-per-energy consumption rate and periodically communicates the determined rate to the display 104. The electronic control unit 102 or a separate display controller may direct the display 104 to display an image based on the determined fuel-equivalent distance-per-energy consumption rate. The electronic control unit 102 may also direct the display 104 to illuminate or de-illuminate a number of lights or light-emitting diodes based on the determined fuel-equivalent distance-per-energy consumption rate and a data sequence stored as an algorithm or a look-up table in a memory.

One benefit of the invention is to show the user a more accurate indication of energy consumption by displaying and determining MPG-e or Km/l-e in real time, thereby allowing the vehicle users to assess the overall energy efficiency of the vehicle 100 or adjust their driving habits to achieve improved overall energy efficiency based on an easily understandable yet accurate metric. An MPG indication based solely on fuel consumption would not be an accurate indication of energy consumption because electrical energy consumption would not be taken into account. A distance-per-energy consumption computed in a conventional vehicle would show an artificially high MPG or Km/l. Another benefit of the invention is that the electronic control unit 102 or another controller/processor may improve an engine operation, a charging/discharging operation, power control, an HVAC operation, tuning or other operations of the units of the vehicle 100 based on the continuously updated MPG-e or Km/l-e. Such a feedback system enhances an overall energy efficiency of the vehicle 100.

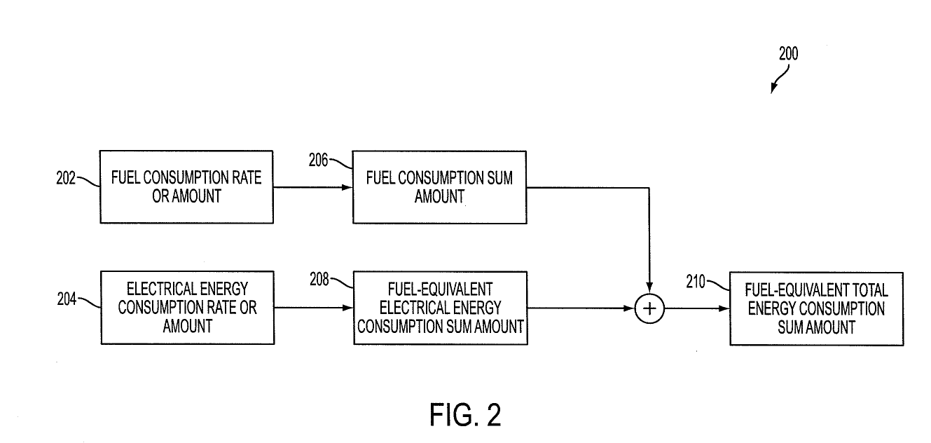

Referring to FIG. 2, the control logic block diagram 200 shows how the fuel-equivalent total energy consumption sum amount may be determined. The fuel consumption rate or amount 202 may be determined during a time period using the rate of injection of fuel, the volume of fuel in the mixture injected, the pulse width and other parameters as discussed above. The fuel consumption sum amount 206 may be determined by for example, integrating or adding the fuel consumption rate or amount 202 over the time period to obtain an initial fuel consumption sum amount expressed in gallons or other units of fuel amount. In a conventional vehicle, the initial fuel consumption sum amount is then converted, using the distance travelled during the time period, into the fuel consumption sum amount 206 in miles per gallon (MPG) or kilometers per liter (Km/l). However, the MPG or Km/l would only correspond to the rate of fuel consumption, not a rate of overall energy consumption.

The control logic block diagram 200 is further configured to determine the electrical energy consumption rate or amount 204 by, for example, monitoring the SOC of the battery 118 as discussed above. An initial fuel-equivalent electrical energy consumption sum amount may be determined by integrating or adding the electrical energy consumption rate or amount 204 over the time period. The initial fuel-equivalent electrical energy consumption sum amount may be converted to the fuel-equivalent electrical energy consumption sum amount 208 expressed, for example, in fuel-equivalent units (gallons or liters). Since both fuel consumption sum amount 206 and the fuel-equivalent electrical energy consumption sum amount 208 may be expressed in fuel-equivalent units, the electronic control unit 102 may add the two values to obtain a fuel-equivalent total energy consumption sum amount 210 expressed in either gallons or liters. The MPG-e or Km/l-e may be computed, using the electronic control unit 102, based on the determined fuel-equivalent total energy consumption sum amount 210 and the distance travelled by the vehicle 100 during the time period.

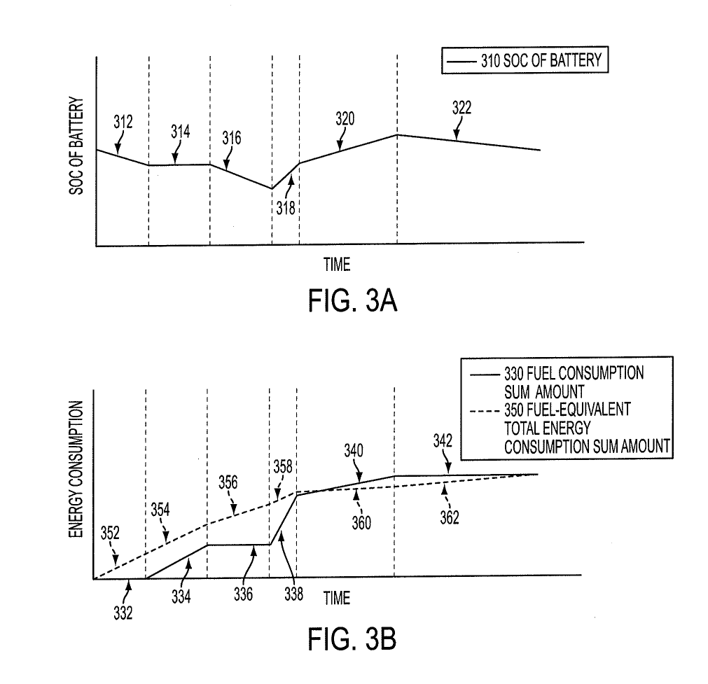

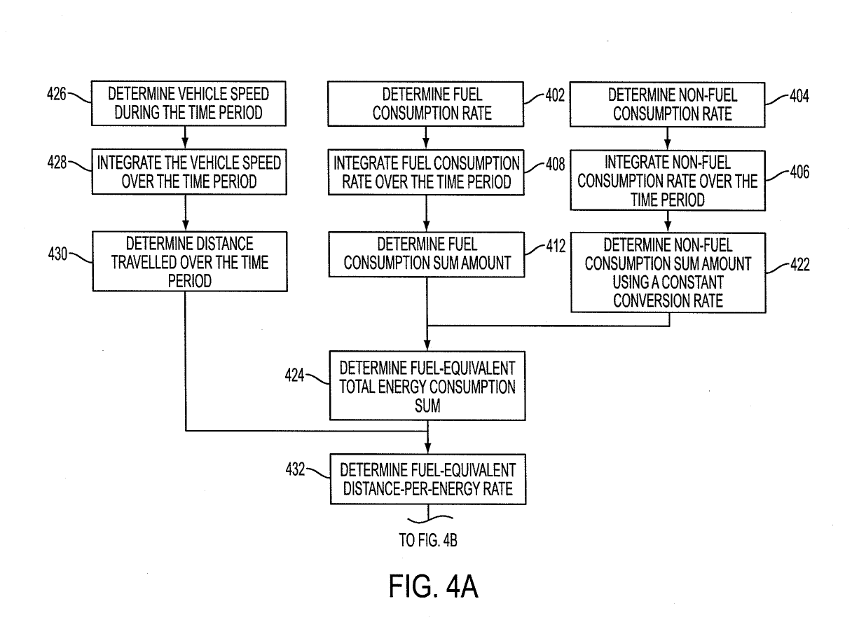

Referring to FIGS. 3A and 3B, the difference between the fuel consumption sum amount 330 (used for calculating MPG in a conventional vehicle) and the fuel-equivalent total energy consumption sum amount 350 is illustrated. FIG. 3A is a graph of an example of a change in the SOC of the battery 118 (on the Y-axis) as a function of time (on the X-axis) during an operation of the vehicle 100. The changes in the SOC are divided into segments (312, 314, 316, 318, 320 and 322) for illustration purposes. FIG. 3B shows the fuel consumption sum amount 330 (illustrated in solid lines) and the fuel-equivalent total energy consumption sum amount 350 (illustrated in broken lines) as the SOC of the battery 118 varies during an operation of the vehicle 100. The fuel consumption sum amount 330 corresponds to the fuel consumption sum amount 206 and the fuel-equivalent total energy consumption sum amount 350 corresponds to the fuel-equivalent total energy consumption sum amount 210 discussed above with respect to FIG. 2.

In one embodiment, the vehicle 100 may be a hybrid vehicle operating alternatively on electricity or fuel. As the SOC of the battery 118 decreases in segment 312, no fuel is being injected into the engine 106. The fuel consumption sum amount 330 remains unchanged as shown in segment 332 because only electrical energy is being depleted. A traditional real-time MPG calculation would report an artificially high MPG since no fuel is being consumed. However, in this embodiment, the electronic control unit 102 recognizes that the fuel-equivalent total energy consumption sum amount 350 is rising as shown in segment 352. A similar pattern applies to the variations in the SOC of the battery 118 in segments 316 and 322, respective fuel consumption sum amounts in segments 336 and 342 and respective fuel-equivalent total energy consumption sum amounts in segments 356 and 362. In segment 314, the SOC of the battery 118 is not being depleted and the vehicle 100 is operating solely on fuel energy from fuel injection. The fuel consumption sum amount 330 in segment 334 and the fuel-equivalent total energy consumption sum amount 350 in segment 354 increase by the same degree or slope.

In order to compute the fuel-equivalent total energy consumption sum amount 350, when the SOC of the battery 118 is increasing, the electronic control unit 102 may distinguish between the sources that provide the stored electrical energy, given that the fuel-equivalent total energy consumption sum amount 350 may depend upon the source of the provided electrical energy and how the vehicle 100 converts a form of energy into the provided electrical energy stored in the battery 118. Referring to FIGS. 3A and 3B, in segment 318, the vehicle 100 is using fuel energy to both drive the vehicle 100 and charge the battery 118 simultaneously. As a result, the fuel consumption sum amount 330 increases in segment 338. Since some of the fuel energy is being stored via charging the battery 118 for later use for an operation of the vehicle 100, the fuel-equivalent total energy consumption sum amount 350 increases in segment 358 at a lower rate than the rate at which the fuel consumption sum amount 330 increases in segment 338. In segment 320, the SOC of the battery 118 is increasing because fuel energy is used to charge the battery 118. As a result, the fuel consumption sum amount 330 increases in segment 340. The conventional vehicle would decrease the MPG or Km/l value in real-time, falsely assuming that fuel energy is lost or converted into kinetic energy whereas the energy is being used to charge the battery 118 for later use for an operation of the vehicle 100. However, the electronic control unit 102 in an embodiment of the present invention recognizes that one form of energy is being converted to another form, thereby maintaining the fuel-equivalent total energy consumption sum amount 350 on approximately the same level in segment 360. In another embodiment, the electronic control unit 102 may slightly increase the fuel-equivalent total energy consumption sum amount 350 in segment 360 depending on the energy conversion efficiency and the amount of energy lost during the charging operation of the battery 118. In sum, the electronic control unit 102 increases the fuel-equivalent total energy consumption sum amount 350 in segments 358 and 360 at a lower rate than the rate at which the fuel consumption sum amount 330 increases in segments 338 and 340.

In an embodiment of the present invention, if fuel is being consumed leading to a rise in the fuel consumption sum amount 330 and if simultaneously, the SOC of the battery 118 increases via recapturing energy generated from a regenerative braking mechanism of the energy generation unit 110, the electronic control unit 102 may not decrease the rate at which the fuel-equivalent total energy consumption sum amount 350 increases (unlike segments 358 and 360 discussed above). The underlying rationale for such an embodiment is that the electrical energy provided for charging the battery 118 is not directly obtained from consumption of fuel energy. As a result, the electronic control unit 102 evaluates the overall energy efficiency, fuel consumption sum amount 330, fuel-equivalent total energy consumption sum amount 350 and fuel-equivalent distance-per-energy consumption rate based on the source of the increase in the SOC of the battery 118.

Similarly, in order to compute the fuel-equivalent total energy consumption sum amount 350, when the SOC of the battery 118 is decreasing, the electronic control unit 102 may distinguish between various discharging operations. For example, if the battery 118 is discharged to power auxiliary loads such as headlights, the HVAC unit and/or other units of the vehicle 100 while the vehicle 100 is in a stationary state, the electronic control unit 102 would recognize that the electrical energy consumed by the auxiliary loads is unrelated to the energy efficiency for a driving operation of the vehicle 100. Therefore, in a stationary state, the electronic control unit 102 may not significantly alter the fuel-equivalent total energy consumption sum amount 350 on the basis of the energy consumed by the auxiliary loads.

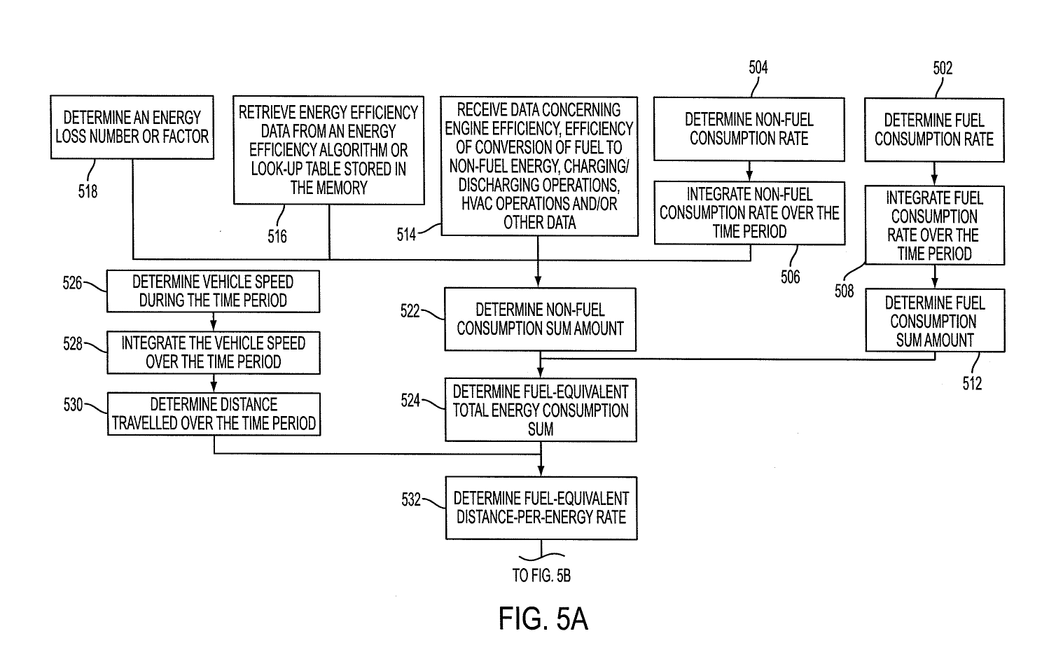

Referring to FIG. 4, a decision flowchart diagram shows a method of determining and displaying a fuel-equivalent distance-per-energy rate according to an embodiment of the present invention. The electronic control unit 102 may be configured to determine the fuel consumption rate in step 402, integrate the fuel consumption rate over the time period in step 408 in order to determine the fuel consumption sum amount in step 412. The fuel consumption sum amount determined in step 412 may initially be in any unit of fuel amount and converted to a number of gallons or liters of fuel consumed. Simultaneously in real time during the operation of the vehicle 100, the electronic control unit 102 may determine the non-fuel consumption rate in step 404, and integrate the non-fuel consumption rate over the time period in step 406 in order to determine the non-fuel consumption sum amount using a constant conversion rate in step 422.

In step 406, the integration may result in a number or value expressed in an initial unit of energy (e.g., kW-h) and then converted into equivalent gallons or liters of equivalent fuel (e.g., gasoline). The fuel-equivalent total energy consumption sum amount may be determined in step 424 by, for example, adding the fuel consumption sum amount from step 412 and non-fuel consumption sum amount from step 422. Simultaneously in real-time during the operation of the vehicle 100, the electronic control unit 102 may determine the vehicle speed during the time period in step 426 and integrate the vehicle speed over the time period in step 428 to determine the distance (in Km or miles) travelled over the time period in step 430 as discussed above. In step 432, the electronic control unit 102 divides the distance from step 430 over the fuel-equivalent total energy consumption sum amount from step 424. The determined fuel-equivalent distance-per-energy rate may be expressed in either MPG-e or Km/l-e.

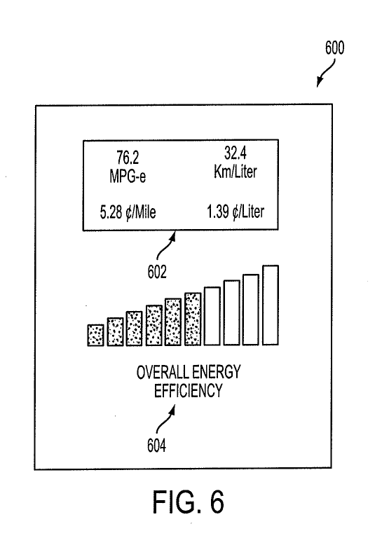

Referring to FIG. 4, in advance of the operation of the vehicle 100 or simultaneously in real time during the operation of the vehicle 100, the electronic control unit 102 may receive a fuel cost amount in step 434 corresponding to for example, a cost per a gallon or a liter of fuel. The fuel cost amount may be received or predetermined through various means and in various currencies or formats. In an alternative embodiment, a non-fuel cost amount such as an electricity cost amount may also be received. For example, the electricity cost amount may be received from a user of the vehicle 100 or from an external power source. The electronic control unit 102 may apply the received fuel cost amount to the fuel consumption sum amount from step 412 and apply the received non-fuel cost amount to the non-fuel consumption sum amount from step 422 in order to determine a fuel-equivalent cost amount. The electronic control unit 102 may then determine and display an indicator in step 436 based on the determined fuel-equivalent cost amount which may correspond to a cost amount for travelling a kilometer or a mile during the time period as discussed below with respect to FIG. 6. The electronic control unit 102 may direct the display 104 to display an indicator showing miles travelled for a gallon of the fuel-equivalent total energy consumption sum amount (MPG-e) in step 438 or kilometers travelled for a liter of the fuel-equivalent total energy consumption sum amount (Km/l-e) in step 440. The electronic control unit 102 may also display an image based on the MPG-e or Km/l-e in step 442 as discussed in details below with respect to FIG. 6.

Referring to FIG. 4, in step 444, the electronic control unit 102 or another controller/processor may improve an engine operation, a charging/discharging operation, power control, an HVAC operation, tuning or other operations of the units of the vehicle 100 based on the determined fuel-equivalent distance-per-energy rate in step 432 in order to achieve a higher overall energy consumption efficiency. Step 444 may also be based on the fuel-equivalent cost amount determined in step 436 in order to change operations of the various units of the vehicle 100 in real time in order to minimize the fuel-equivalent cost amount. Such a feedback system enhances an overall energy efficiency of the vehicle 100 and/or minimizes the cost of total energy consumption in real time. Each step is repeated periodically (e.g., every 500 milliseconds) as shown in step 446, thereby allowing the feedback system of step 444 and the displayed images and indicators in steps 436, 438, 440 and 442 to depend upon the real time energy consumption values.

FIG. 5 is a decision flowchart diagram showing a method of determining and displaying a fuel-equivalent distance-per-energy rate based on the determined energy loss number or factor (instead of a constant pre-determined conversion factor) according to yet another embodiment of the present invention. Steps 502, 504, 506, 508 and 512 correspond to steps 402, 404, 406, 408 and 412 described above with respect to FIG. 4. In an embodiment, in step 518, instead of using a constant conversion factor as discussed with respect to FIG. 4, the electronic control unit 102 may determine an energy loss number or factor based on feedbacks received regarding a current operation of the engine 106, a charging/discharging operation of the BMCU 116, an energy generation operation of the energy generation unit 110, fuel consumption data received from the engine fuel controller 108, driving habits of the driver, power consumed by the HVAC unit and/or other devices of the vehicle 100 in which a substantial amount of energy is lost.

Referring to FIG. 5, an underlying rationale for utilizing energy conversions based on an energy loss number or factor, instead of solely a pre-determined constant conversion factor, is that the energy loss amount may heavily depend upon the source of the electrical energy stored in the battery 118 and the efficiency of conversion of a form of energy into the electrical energy. For example, when fuel energy is consumed in order to charge the battery 118 in a hybrid-electrical vehicle, some of the energy may be lost in engine 106, in the motor/generator or during a charging operation of the battery 118. For example, in an initial acceleration and low-speed driving, the motor/generator may use electricity from the battery 118 to power the vehicle 100. If the battery 118 needs to be recharged, the motor/generator starts the engine 106 and converts energy from the engine 106 into electricity, which is stored in the battery 118. The energy lost during this process before the electrical energy is available in the battery 118 is substantially greater than energy lost when the electrical energy is obtained from an external power source (for example, in a plug-in hybrid vehicle) when the vehicle 100 is in a stationary state. As such, the electronic control unit 102 may initially determine the source of the electrical energy based on data received from the charger 112 or the BMS 114 regarding the charging/discharging operation. Engine efficiency and energy lost during an engine operation may be ignored if the vehicle 100 is not operated and is charged by an external power source in a stationary state.

For a conventional hybrid vehicle, an accurate MPG-e or Km/1-e indication may require determination of an energy loss number or factor given that most or all of the energy in the battery 118 has been obtained from the engine 106. Although in a standard condition, 33.7 kWh of non-fuel energy may equate to the energy stored in a gallon of gasoline, only a percentage of the energy may be available for later use. As such, the electronic control unit 102 may consider the energy lost based on engine efficiency, the energy lost when fuel energy is being converted into electrical energy stored in the battery 118 and energy lost during a charging operation of the battery 118. For example, as discussed above with respect to FIGS. 3A and 3B, when fuel is consumed in segment 340 and the consumed energy is converted into electrical energy, the fuel-equivalent total energy consumption sum amount 350 may slightly increase because only a percentage of the fuel energy may be available for later use in an operation of the vehicle 100 due to the energy lost during the energy conversion operations. In one embodiment, the memory may store energy efficiency data which matches an energy loss amount with a given torque or speed of the engine 106 during an operation of the vehicle 100. As shown in FIG. 5, the electronic control unit 102 may then determine an energy loss number or factor in step 518 by receiving engine torque and speed data in step 514 and looking up or calculating an energy loss number or factor by retrieving energy efficiency data corresponding to the received engine torque or speed from the memory in step 516. As such, these steps may be performed in real time during an operation of the vehicle 100 in order to determine non-fuel consumption sum amount in step 522 based on the current operations of the vehicle 100. Similar look-up tables, algorithms or data with respect to an operation of the HVAC unit, a charging/discharging operation of the BMCU 116, driving patterns, other data regarding energy efficiency and combinations thereof may be utilized by the electronic control unit 102 to determine a further accurate fuel-equivalent distance-per-energy rate in step 532. The remaining steps may be performed as discussed with respect to FIG. 4 in order to display distance-per-energy consumption and cost-per-distance travelled indicators.

FIG. 6 shows a display screen 600 of the display 104 of the vehicle 100 having indicators showing the fuel-equivalent distance-per-energy rate, a cost-per-distance travelled corresponding to the determined fuel-equivalent cost amount and the total energy efficiency, each being determined and updated in real time as the vehicle 100 is operated according to an exemplary embodiment of the present invention. The image may be displayed using an LCD, an organic light emitting display, a plasma display, light-emitting diodes or any other display mechanism for displaying the data. The image 602 may display the determined cost-per-distance travelled and distance-per-energy consumption rates in various units.

As shown in FIG. 6, an overall energy efficiency indicator 604 may also be displayed to show the vehicle user the level of energy efficiency currently being achieved. For example, 6 bars out of 10 bars may be displayed in order to show the vehicle user that although a higher than average energy efficiency is achieved, by further adjusting driving habits the vehicle user may be able to improve energy efficiency. For example, increasing-efficiency thresholds and decreasing-efficiency thresholds may be stored in the memory. As the MPG-e or the Km/l-e increases above an increasing-efficiency threshold, an additional horizontal bar may be illuminated in real time to indicate that a higher energy efficiency value (MPG-e or Km/l-e) is currently being achieved, and as the MPG-e or the Km/l-e decreases below a decreasing-efficiency threshold, an illuminated horizontal bar may be de-illuminated in real time to indicate that a lower energy efficiency value (MPG-e or Km/l-e) is currently being achieved. In one embodiment, the electronic control unit 102 communicates the monitored parameters including the determined cost-per-distance and fuel-equivalent distance-per-energy rate to the display 104 using transmission of an electronic signal through a Control Area Network (CAN) bus. In other embodiments, the control and communication may be over various other types of serial communication links, direct wirings, digital communication buses, wireless communications or other communication links.

The logical modules and steps for the vehicle 100 described in connection with the examples disclosed above may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A computer-based method for determining and displaying a fuel-equivalent distance-per-energy consumption rate of a vehicle, the method comprising:
determining, using a fuel controller coupled to an engine or a fuel cell, a fuel consumption rate or amount;
determining, using a battery management and charging unit (BMCU) coupled to a battery, an electrical energy consumption rate or amount;
determining, using an electronic control unit coupled to a speed sensor, a distance travelled by the vehicle during a time period;
determining, using the electronic control unit, the fuel-equivalent distance-per-energy consumption rate based on the fuel and electrical energy consumption rates or amounts and based on the determined distance travelled during the time period; and
displaying, using a display coupled to the electronic control unit, an indicator based on the fuel-equivalent distance-per-energy consumption rate for indicating an amount of distance travelled by the vehicle for an amount of fuel-equivalent energy consumed.

2. The method of claim 1, further comprising:
determining, using the electronic control unit, a fuel consumption sum amount consumed during the time period based on the determined fuel consumption rate or amount; and
determining, using the electronic control unit, a fuel-equivalent electrical energy consumption sum amount consumed during the time period based on the determined electrical energy consumption rate or amount,
wherein the step of determining the fuel-equivalent distance-per-energy consumption rate is further based on the fuel consumption sum amount and the fuel-equivalent electrical energy consumption sum amount.

3. The method of claim 2, further comprising determining, using the electronic control unit, a fuel-equivalent total energy consumption sum amount based on the fuel consumption sum amount and the fuel-equivalent electrical energy consumption sum amount, wherein the step of determining the fuel-equivalent distance-per-energy consumption rate is further based on the determined fuel-equivalent total energy consumption sum amount.

4. The method of claim 3, wherein:
the step of determining the fuel-equivalent total energy consumption sum amount includes adding, using the electronic control unit, the fuel consumption sum amount and the fuel-equivalent electrical energy consumption sum amount, and
the step of determining the fuel-equivalent distance-per-energy consumption rate includes dividing, using the electronic control unit, the distance travelled during the time period by the fuel-equivalent total energy consumption sum amount.

5. The method of claim 4, wherein:
the step of determining the fuel consumption sum amount includes integrating or adding, using the electronic control unit, the fuel consumption rate or amount over the time period,
the step of determining the fuel-equivalent electrical energy consumption sum amount includes integrating or adding, using the electronic control unit, the electrical energy consumption rate or amount over the time period to obtain an initial electrical energy consumption sum amount and multiplying, using the electronic control unit, the initial electrical energy consumption sum amount by an energy conversion factor.

6. The method of claim 5, wherein the step of determining the fuel-equivalent distance-per-energy consumption rate is performed periodically during an operation of the vehicle.

7. The method of claim 6, further comprising determining, using the electronic control unit, an energy loss number or factor corresponding to energy lost when fuel energy is converted into electrical energy stored in the battery,
wherein the step of determining the fuel-equivalent distance-per-energy consumption rate is further based on the determined energy loss number or factor.

8. The method of claim 1, wherein the step of determining the fuel consumption rate or amount is based on a consumption rate or amount of a fuel selected from a group consisting of gasoline, diesel, ethanol, biodiesel, natural gas, propane, hydrogen and combinations thereof.

9. The method of claim 1, further comprising determining, using the electronic control unit and an energy generation unit of the vehicle, an energy generation rate or amount of the energy generation unit, wherein the energy generation unit includes a solar panel, a ram induction generator, a regenerative braking unit, a heat exchange unit or combinations thereof,
wherein the step of determining the fuel-equivalent distance-per-energy consumption rate is further based on the determined energy generation rate or amount of the energy generation unit.

10. The method of claim 3, wherein the indicator corresponds to a number of or a fraction of miles of the distance travelled per a gallon of the fuel-equivalent total energy consumption sum amount, or corresponds to a number of or a fraction of kilometers of the distance travelled per a liter of the fuel-equivalent total energy consumption sum amount.

11. The method of claim 1, further comprising:
receiving, using the electronic control unit, a fuel cost amount;
receiving, using the electronic control unit, an electricity cost amount;
determining, using the electronic control unit, a fuel-equivalent energy cost amount based on the received fuel cost amount, the received electricity cost amount and the determined fuel-equivalent distance-per-energy consumption rate such that the fuel-equivalent energy cost amount corresponds to a cost of consuming fuel and fuel-equivalent non-fuel energy for a kilometer or a mile of the travelled distance over the time period; and
displaying, using the display, a cost indicator corresponding to the determined fuel-equivalent energy cost amount.

12. The method of claim 11, further comprising changing, using the electronic control unit, an operation of the engine or a charging or discharging operation of the BMCU based on the determined fuel-equivalent distance-per-energy consumption rate or the determined fuel-equivalent energy cost amount.

13. The method of claim 1, further comprising:
providing, by the display, at least one or more lights, each light illuminated or de-illuminated based on the fuel-equivalent distance-per-energy consumption rate;
illuminating, using a display controller coupled to the display, at least one light of the one or more lights when the fuel-equivalent distance-per-energy consumption rate increases to a number greater than an increasing-efficiency threshold; and
de-illuminating, using the display controller, at least one light of the one or more lights when the fuel-equivalent distance-per-energy consumption rate decreases to a number less than a decreasing-efficiency threshold.

14. A computer-based method for determining and displaying a fuel-equivalent distance-per-energy rate of a vehicle, the method comprising:
determining, using a fuel controller coupled to an engine or a fuel cell, a first energy consumption sum amount corresponding to an amount of fuel energy consumed by an engine or a fuel cell during a time period;
determining, using an electronic control unit, a second energy consumption sum amount corresponding to an amount of energy consumed using a non-fuel energy source during the time period;
determining, using the electronic control unit and a speed sensor coupled to the electronic control unit, a distance travelled by the vehicle during the time period;
determining, using the electronic control unit, a fuel-equivalent total energy consumption sum amount based on the first and the second consumption sum amounts;
determining, using the electronic control unit, the fuel-equivalent distance-per-energy consumption rate based on the determined fuel-equivalent total energy consumption sum amount and the determined distance travelled during the time period, such that the fuel-equivalent distance-per-energy consumption rate corresponds to a number of or a fraction of miles travelled per a gallon of the fuel-equivalent total energy consumption sum amount or corresponds to a number of or a fraction of kilometers travelled per a liter of the fuel-equivalent total energy consumption sum amount; and
displaying, using a display coupled to the electronic control unit, an indicator based on the determined fuel-equivalent distance-per-energy consumption rate.

15. The method of claim 14, further comprising:
receiving, using the electronic control unit, a fuel cost amount;
determining, using the electronic control unit, a fuel-equivalent energy cost amount based on the received fuel cost amount and the determined fuel-equivalent distance-per-energy consumption rate such that the fuel-equivalent energy cost amount corresponds to a cost of consuming fuel and fuel-equivalent non-fuel energy for a kilometer or a mile of the travelled distance over the time period; and
displaying, using the display, a cost indicator corresponding to the determined fuel-equivalent energy cost amount.

16. The method of claim 15, further comprising changing, using the electronic control unit, an operation of the engine or a charging or discharging operation of the BMCU based on the determined fuel-equivalent distance-per-energy consumption rate or the determined fuel-equivalent energy cost amount.

17. A vehicle comprising:
an engine;
a fuel controller coupled to the engine and configured to determine a fuel consumption rate or amount of the engine;
a battery management and charging unit (BMCU) coupled to a battery and configured to control and monitor charging and discharging of the battery and further configured to determine an electrical energy consumption rate or amount of the battery;
an energy generation unit including a solar panel, a ram induction generator, a regenerative braking unit, a heat exchange unit or combinations thereof, the energy generation unit having an energy generation rate or amount;
an electronic control unit coupled to the engine, the energy generation unit, the fuel controller and the BMCU and configured to:
determine, using a speed sensor, a distance travelled by the vehicle during a time period, and
determine a fuel-equivalent distance-per-energy consumption rate based on the determined fuel consumption rate or amount, electrical energy consumption rate or amount, energy generation rate or amount and the distance travelled during the time period; and
a display coupled to the electronic control unit and configured to display an indicator based on the determined fuel-equivalent distance-per-energy consumption rate, the indicator corresponding to an amount of distance travelled by the vehicle for an amount of fuel-equivalent energy consumed.

18. The vehicle of claim 17, wherein:
the electronic control unit is further configured to:
receive a fuel cost amount,
determine a fuel-equivalent energy cost amount based on the received fuel cost amount and the determined fuel-equivalent distance-per-energy consumption rate such that the fuel-equivalent energy cost amount corresponds to a cost of consuming fuel and fuel-equivalent non-fuel energy for a kilometer or a mile of the travelled distance over the time period, and
change an operation of the engine or a charging or discharging operation of the BMCU based on the determined fuel-equivalent distance-per-energy consumption rate or based on the determined fuel-equivalent energy cost amount,
wherein the display is further configured to display a cost indicator corresponding to the determined fuel-equivalent energy cost amount.

19. The vehicle of claim 17, wherein the electronic control unit is further configured to:
determine an energy loss number or factor based on:
a first energy loss amount corresponding to energy lost when a fuel energy is converted into an electrical energy stored in the battery,
a second energy loss amount corresponding to energy lost when the battery is charged using an external charger coupled to the BMCU or to the battery,
a third energy loss amount corresponding to energy lost when the battery is discharged to power an operation of the vehicle, and
energy efficiency data stored in a memory coupled to or integrated in the electronic control unit,
wherein the electronic control unit is further configured to determine the fuel-equivalent distance-per-energy consumption rate based on the determined energy loss number or factor.

20. The vehicle of claim 17, wherein the indicator is a text or a number corresponding to the determined fuel-equivalent distance-per-energy consumption rate, and the indicator is displayed on a display screen of the display.
